(19) United States
(12) Patent Application Publication
(10) Pub. No.: US 2012/0244002 A1
(43) Pub. Date: Sep. 27, 2012

(54) TURBINE BUCKET ASSEMBLY AND METHODS FOR ASSEMBLING SAME

(76) Inventor: Hari Krishna Meka, Bangalore (IN)

(21) Appl. No.: 13/072,312

(22) Filed: Mar. 25, 2011

(51) Int. Cl. F01D 5/30; B23P 15/00

(52) U.S. Cl. 416/219 R; 29/889.2

(57) ABSTRACT

A turbine bucket for use with a turbine engine. The turbine bucket includes a shank and a platform bordered by a forward edge and an aft edge that are coupled together by a pair of side edges, the forward edge upstream from the aft edge. The platform includes at least one interlock seal extending outward from at least one of the side edges and a mating groove defined in at least one of the side edges, the groove sized to receive the at least one interlock seal extending from an adjacent turbine bucket.

### BACKGROUND OF THE INVENTION

The subject matter described herein relates generally to gas turbine engines and, more particularly, to a bucket assembly for use with a turbine engine.

At least some known rotor assemblies used with turbine engines include at least one row of rotor blades that are circumferentially spaced about a rotor shaft. Each rotor blade includes an airfoil that includes a pressure side and an opposite suction side that are connected together along leading and trailing edges. Each airfoil extends radially outward from a rotor blade platform. Each rotor blade also includes a dovetail that extends radially inward from a shank defined between the platform and the dovetail. The dovetail is used to couple the rotor blade to a rotor disk or rotor spool. During operation, leakage of an operating fluid may occur between the rotor blade platform and the rotor disk. Depending on the amount of leakage, turbine performance and output may be adversely impacted. The leakage of the operating fluid between the rotor blade platform and the rotor disk can lead to a decreased turbine efficiency and/or excess wear on the rotor assembly.

### BRIEF DESCRIPTION OF THE INVENTION

In one aspect, a turbine bucket for use with a turbine engine is provided. The turbine bucket includes a shank and a platform bordered by a forward edge and an aft edge that are coupled together by a pair of side edges, the forward edge upstream from the aft edge. The platform includes at least one interlock seal extending outward from at least one of the side edges and a mating groove defined in at least one of the side edges, the groove sized to receive the at least one interlock seal extending from an adjacent turbine bucket.

In another aspect, a turbine engine system is provided. The turbine engine system includes a rotor disk rotatably coupled to a turbine and a plurality of circumferentially-spaced turbine buckets coupled to the rotor disk. Each of the plurality of turbine buckets includes a shank and platform bordered by a forward edge and an aft edge coupled together by a pair of side edges. The platform includes at least one interlock seal extending outward from at least one of the side edges and a mating groove defined in at least one of the side edges, the groove sized to receive the interlock seal extending from an adjacent turbine bucket.

In another aspect, a method for assembling a turbine engine system is provided. The method includes providing at least two turbine buckets that each include a platform bordered by a forward edge and an aft edge that are coupled together by a pair of side edges, coupling each turbine bucket to a rotor disk such that at least one projection extending from at least one of the platform forward and aft edges is received in a groove defined in the rotor disk, and coupling together the at least two turbine buckets, such that at least one interlock seal extending from at least one of the platform side edges enables a pair of circumferentially adjacent turbine buckets to interlock together.

### BRIEF DESCRIPTION OF THE DRAWINGS

FIG. 1 is schematic illustration of an exemplary known turbine engine system.

FIG. 2 is an enlarged perspective view of an exemplary rotor blade assembly that may be used with the turbine engine system shown in FIG. 1.

FIG. 3 is an enlarged perspective view of a portion of the rotor assembly shown in FIG. 2.

### DETAILED DESCRIPTION OF THE INVENTION

The exemplary methods and systems described herein overcome at least some disadvantages of known rotor blade assemblies by providing a rotor blade assembly that facilitates reducing undesirable leakage of operating fluid between the rotor blade and the rotor disk. As used herein, the term “rotor blade” is used interchangeably with the term “bucket” and thus can include any combination of a bucket including a platform and dovetail and/or a bucket that is integrally formed with the rotor disk, either of which may include at least one airfoil segment. Similarly, the term “rotor blade” also includes a stator ring or stator blade.

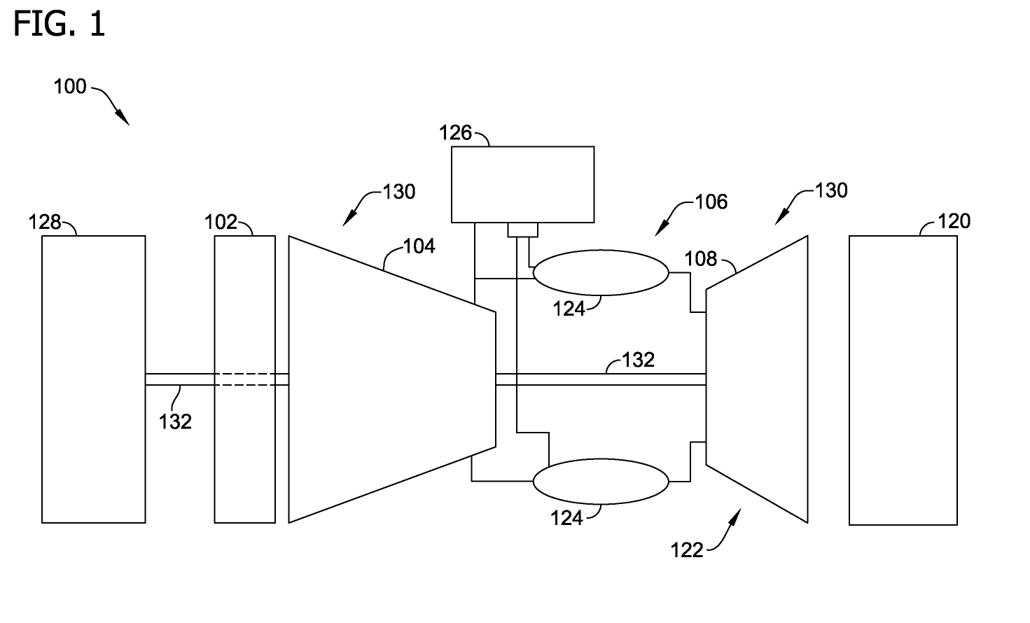

FIG. 1 is a schematic view of an exemplary gas turbine engine 100. In the exemplary embodiment, gas turbine engine 100 includes an intake section 102, a compressor section 104 coupled downstream from intake section 102, a combustor section 106 coupled downstream from compressor section 104, a turbine section 108 coupled downstream from combustor section 106, and an exhaust section 120. Turbine section 108 includes a rotor assembly 122 that is coupled to compressor section 104 via a drive shaft 132. Combustor section 106 includes a plurality of combustors 124. Combustor section 106 is coupled to compressor section 104 such that each combustor 124 is in flow communication with compressor section 104 and such that a fuel nozzle assembly 126 is coupled to each combustor 124. Turbine section 108 is rotatably coupled to compressor section 104 and to a load 128 such as, but not limited to, an electrical generator and/or a mechanical drive application. In the exemplary embodiment, compressor section 104 and turbine section 108 each include at least one turbine blade or bucket 130, having airfoil portions, that is coupled to rotor assembly 122.

During operation, intake section 102 channels air towards compressor section 104. Compressor section 104 compresses the inlet air to a higher pressure and temperature and discharges the compressed air towards combustor section 106. The compressed air is mixed with fuel and is ignited to generate combustion gases that flow to turbine section 108. Turbine section 108 drives compressor section 104 and/or load 128. Specifically, at least a portion of compressed air supplied to fuel nozzle assembly 126. Fuel is channeled to each fuel nozzle assembly 26 wherein it is mixed with the air and ignited in combustor section 106. Combustion gases are generated and channeled to turbine section 108 wherein thermal energy is converted to mechanical rotational energy. Exhaust gases exit turbine section 108 and flow through exhaust section 120 to ambient atmosphere.

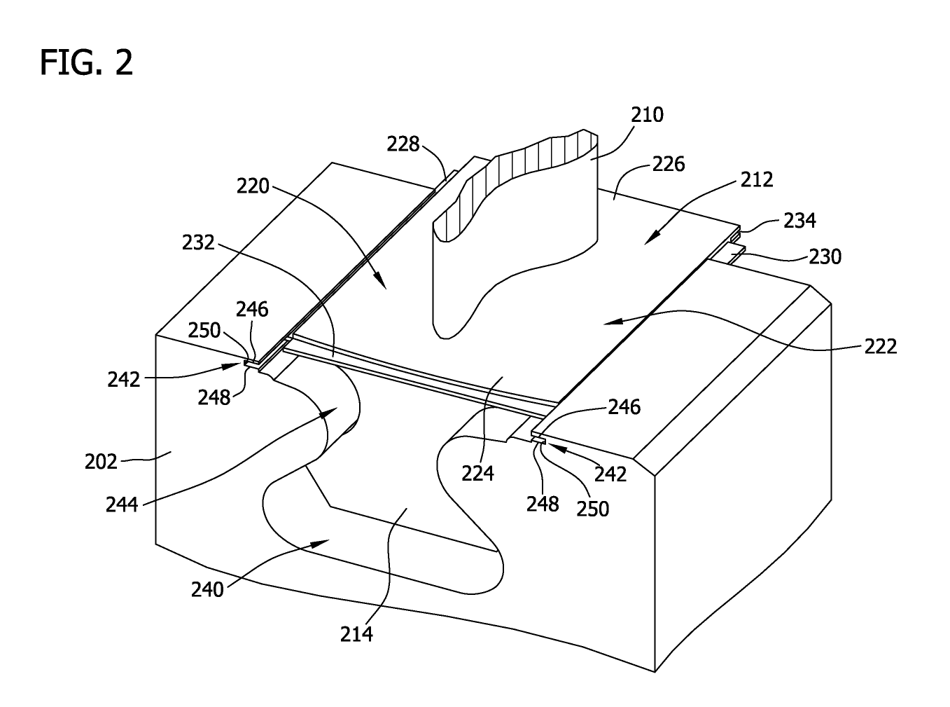

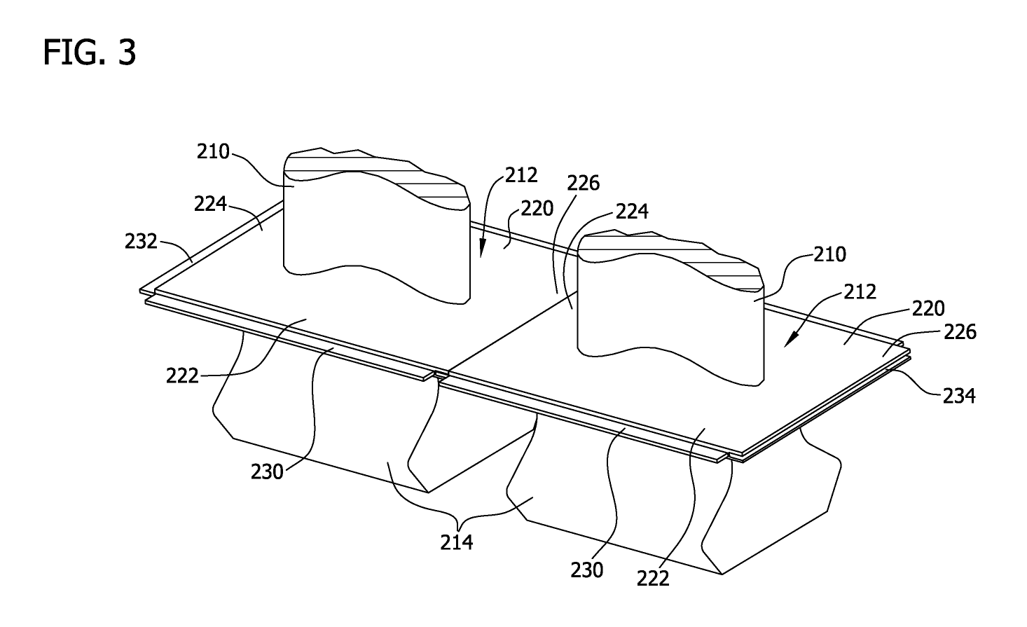

FIG. 2 is an enlarged perspective view of an exemplary rotor assembly 122 that may be used with gas turbine engine 100 (shown in FIG. 1). FIG. 3 is an enlarged perspective view of a portion of rotor assembly 122. In the exemplary embodiment, rotor assembly 122 includes at least one rotor blade 200 coupled to a rotor disk or wheel 202. In the exemplary embodiment, each rotor blade 200 is coupled to a rotor disk 202 that is rotatably coupled to a rotor shaft, such as drive shaft 132 (shown in FIG. 1). In an alternative embodiment, rotor blades 200 are mounted within a rotor spool (not shown). In the exemplary embodiment, each rotor blade 200 extends radially outward from rotor disk 102 and includes an airfoil 210, a dovetail platform 212, and a shank 214. In the exemplary embodiment, shank 214 is in a dovetail configuration.

In the exemplary embodiment, dovetail platform 212 includes a forward edge 220, an aft edge 222, a first side 224, and a second side 226. Dovetail platform 212 also includes a forward projection 228 and an aft projection 230 that are each located on respective edges 220 and 222 of dovetail platform 212. In one embodiment, projections 228 and 230 extend in a tapered shape outward from platform 212. Moreover, projections 228 and 230 are oriented and shaped to mate with a respective groove 242 formed within rotor disk 102. In an alternative embodiment, projections 228 and 230 are formed with a cross-sectional shape that is at least partially concave. A mating projection or interlock seal 232 extends outward from each edge 220 and 222 along platform first side 224 to facilitate mating with an adjacent rotor blade 200. Similarly, a mating groove 234 is formed from edge 220 to edge 222 along platform second side 226. Mating groove 234 is oriented and sized to receive a respective seal 232 extending from adjacent rotor blade 200. In one embodiment, mating groove 234 includes a c-clamp seated within groove 234 configured to retain seal 232. In one embodiment, mating groove 234 has a depth and a height of between about 1 millimeter to about 500 millimeters. In the exemplary embodiment, the depth and height of each groove 234 is about 30 millimeters.

In the exemplary embodiment, rotor disk 202 includes a slot 240 and platform grooves 242 that are sized and oriented to receive blade 200 therein. Slot 240 has a dovetail shaped configuration to receive shank 214. Platform grooves 242 are defined on each side of an upper portion 244 of slot 240, and are each oriented and sized to receive forward projection 228 and aft projection 230 therein. More specifically, grooves 242 are oriented and shaped to receive projections 228 and 230 therein in a friction fit. In one embodiment, grooves 242 include a c-clamp seated within grooves 242 to retain projections 228 and 230. Each platform groove 242 is defined by an upper groove wall 246, a lower groove wall 248, and an inner groove wall 250 of rotor disk 202. In the exemplary embodiment, walls 246, 248, and 250 each have a length of between about 1 mm to about 100 mm. In one exemplary embodiment, each groove wall 246, 248, and 250 have a length of about 30 mm. In one embodiment, platform grooves 242 have 3 a cross-sectional shape that is shaped to substantially mirror that of projections 228 and 230. For example, in the exemplary embodiment, grooves 242 share a concave cross-sectional shaped that substantially mirrors the cross-sectional shape of projections 228 and 230.

In an alternative embodiment, dovetail platform 212 includes a rotor disk groove located on each of forward edge 220 and aft edge 222, such that the rotor disk grooves are each sized and oriented to receive projections extending from rotor disk 202. In the alternative embodiment, mating grooves 234 are formed on first side 224 and second side 226 such that mating grooves 234 are each sized and oriented to receive projections extending from rotor disk 202. Grooves located on each of forward edge 220, aft edge 222, first side 224, and second side 226 are configured to receive a projection extending from rotor disk 202 to couple adjacent rotor blades 200 and to couple rotor blade 200 to rotor disk 202. In an alternative embodiment, any combination of projections and grooves located on platform 212 and rotor disk 202 may be used to facilitate coupling and substantially sealing adjacent rotor blades 200 and rotor blade 200 to rotor disk 202 as described herein.

During operation, in the exemplary embodiment, adjacent rotor blades 200 are coupled together such that a dovetail platform 212 of a first rotor blade 200 interlocks with a mating projection 232 extending from an adjacent rotor blade 200. Additionally, rotor blade projections 228 and 230 each interlock with rotor disk 202. Interlocking rotor blade 200 with rotor disk 202 and adjacent rotor blades 200 substantially reduces leakage between rotor blade 200 and rotor disk 202. Moreover, interlocking adjacent rotor blades 200 substantially reduces leakage between rotor blades 200.

The above-described turbine blades overcome at least some disadvantages of known turbine blades by substantially reducing leakage between pairs of adjacent turbine blades, and between each rotor blade and the rotor disk. Moreover, the interlocking blades facilitate reducing the need for additional parts for sealing, such as rope seals, and this improves the useful life of a rotor assembly and/or a turbine. Moreover, the current disclosure describes a rotor assembly that is configured to facilitate reducing leakages therein. By reducing the turbine blade leakage, operating efficiency of the turbine engine and costs savings are each increased.

Exemplary embodiments of a turbine blade for use in a turbine engine and methods of assembling the same are described herein in detail. The methods and apparatus are not limited to the specific embodiments described herein, but rather, components of systems and/or steps of the method may be utilized independently and separately from other components and/or steps described herein. For example, the methods and apparatus may also be used in combination with other combustion systems and methods, and are not limited to practice with only the gas turbine engine assembly as described herein. Rather, the exemplary embodiment can be implemented and utilized in connection with many other combustion system applications.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine bucket for use with a turbine engine, said turbine bucket comprising:
a shank; and
a platform bordered by a forward edge and an aft edge that are coupled together by a pair of side edges, said forward edge upstream from said aft edge, said platform comprising:
at least one interlock seal extending outward from at least one of said side edges; and
a mating groove defined in at least one of said side edges, said groove sized to receive said at least one interlock seal extending from an adjacent turbine bucket.

2. A turbine bucket in accordance with claim 1, further comprising an airfoil extending outwardly from said platform.

3. A turbine bucket in accordance with claim 1, wherein said shank comprises a dovetail.

4. A turbine bucket in accordance with claim 1, wherein said at least one interlock seal has a tapered cross-sectional shape.

5. A turbine bucket in accordance with claim 1, wherein said platform further comprises:
a first projection extending outward from said forward edge; and
a second projection extending outward from said aft edge.

6. A turbine bucket in accordance with claim 5, wherein at least one of said first projection and said second projection is at least partially concave.

7. A turbine engine system comprising:
a rotor disk rotatably coupled to a turbine; and
a plurality of circumferentially-spaced turbine buckets coupled to said rotor disk, each of said plurality of turbine buckets comprising:
a shank; and
a platform bordered by a forward edge and an aft edge that are coupled together by a pair of side edges, said forward edge upstream from said aft edge, said platform comprising:
at least one interlock seal extending outward from at least one of said side edges; and
a mating groove defined in at least one of said side edges, said groove sized to receive said at least one interlock seal extending from an adjacent turbine bucket.

8. A turbine engine system in accordance with claim 7, wherein the rotor disk further comprises at least one rotor disk projection oriented and sized to be received by said platform.

9. A turbine engine system in accordance with claim 8, wherein said platform further comprises at least one rotor disk groove configured to receive said at least one rotor disk projection.

10. A turbine engine system in accordance with claim 7, wherein said at least one interlock seal has a tapered cross-sectional shape.

11. A turbine engine system in accordance with claim 7, wherein said platform further comprises:
a first projection extending outward from said forward edge; and
a second projection extending outward from said aft edge.

12. A turbine engine system in accordance with claim 11, wherein at least one of said first projection and said second projection is at least partially concave.

13. A turbine engine system in accordance with claim 9, wherein said rotor disk comprises a dovetail slot configured to receive said dovetail shank.

14. A turbine engine system in accordance with claim 7, wherein said rotor disk comprises at least one groove configured to receive at least one of said first projection and said second projection extending outward from said forward edge and said aft edge.

15. A turbine engine system in accordance with claim 14, wherein said at least one rotor disk groove is at least partially concave.

16. A method for assembling a turbine engine system, said method comprising:
providing at least two turbine buckets that each include a platform bordered by a forward edge and an aft edge that are coupled together by a pair of side edges;
coupling each turbine bucket to a rotor disk such that at least one projection extending from at least one of the platform forward and aft edges is received in a groove defined in the rotor disk; and
coupling together the at least two turbine buckets, such that at least one interlock seal extending from at least one of the platform side edges enables a pair of circumferentially adjacent turbine buckets to interlock together.

17. A method in accordance with claim 16, wherein coupling each turbine bucket to a rotor disk further comprises coupling each turbine bucket to a rotor disk such that a dovetail shank extending from each platform is received in a dovetail slot defined in the rotor disk.

18. A method in accordance with claim 16, wherein coupling each turbine bucket to a rotor disk further comprises coupling each turbine bucket to a rotor disk such that an airfoil extends radially outward from each platform.

19. A method in accordance with claim 16, wherein coupling each turbine bucket to a rotor disk further comprises coupling each turbine bucket to a rotor disk such that the at least one projection is at least partially concave and extends outward from at least one of the forward edge and the aft edge and is received in an at least partially concave groove defined in the rotor disk.

20. A method in accordance with claim 16, wherein coupling each turbine bucket to a rotor disk further comprises coupling each turbine bucket to a rotor disk such that the at least one projection is at least partially tapered and extends outward from at least one of the forward edge and the aft edge and is received in a groove defined in the rotor disk
